(19) United States
(12) Patent Application Publication
(10) Pub. No.: US 2020/0060309 A1
(43) Pub. Date: Feb. 27, 2020

(54) PLANT SUBSTITUTES FOR MEAT FOOD PRODUCTS

(71) Applicant: ODONTELLA, Bordeaux (FR)

(72) Inventors: Pierre CALLEJA, Bordeaux (FR); Alain GUILLOU, Bordeaux (FR)

(21) Appl. No.: 16/610,606

(22) PCT Filed: Apr. 5, 2018
(86) PCT No.: PCT/EP2018/061502

§ 371 Date: Nov. 4, 2019

(30) Foreign Application Priority Data
May 4, 2017 (FR) FR1770453

(51) Int. Cl. A23J 3/22; A23L 17/60; A23J 3/14

(52) U.S. Cl. CPC A23J 3/227; A23V 2002/00; A23J 3/14; A23L 17/60

(57) ABSTRACT

The invention relates to a foodstuff having a fibrous structure comprising:
at least one plant constituent of aquatic origin selected from among microalgae or microalgae extracts, cyanobacteria or cyanobacteria extracts and marine fungi or marine fungi extracts of the genus Schizochytrium and Auriantochytrium, or a mixture of at least two of these constituents of aquatic origin, and
at least one other plant constituent,
   said constituent of aquatic origin or the mixture of at least two of said constituents of aquatic origin constituting at least 5% by weight of the foodstuff.

The invention also relates to the use of such a foodstuff as a meat food product substitute.

The present invention relates to substitutes for meat food products and in particular fish, meat and derived products.

The consumption of food products of animal origin, both marine and terrestrial, is increasingly criticized. Today, livestock farming and industrial aquaculture have significant consequences for humans, animals and the environment:
Adverse effect on health: overconsumption of animal products is at the root of many diseases in humans (cardiovascular, inflammatory, diabetes, etc.); significant presence of certain pollutants in the animal products consumed; outbreak of frequent epizootics; excessive use of antibiotics which contributes to the occurrence of resistant bacterial strains;
Mistreatment of animals;
Leading source of greenhouse gas production, soil, surface water and groundwater pollution and intensive deforestation.

Let us look at the case of salmon, for example, which is the most produced aquaculture species in Europe. For several years, salmon consumption has increased dramatically to the detriment of other wildlife species. This high consumption makes it possible to provide humans with additional animal protein but does not cover the necessary intake of other essential nutrients such as long-chain polyunsaturated fatty acids, which are essential for good health. In fact, farmed salmon is of low quality and contains synthetic chemical pigments and vegetable oil, and little or no DHA. In addition, salmon now contains high levels of pollutants, including fishmeal for feeding farmed fish that contains endocrine disruptors, heavy metals, and pesticide residues. Antibiotics are also generally used in intensive fish farming, leaving traces of these compounds in the fish flesh. At least 4 kg of marine fishmeal is required for the production of 1 kg of farmed salmon, resulting in an exponential destruction of wild fish stocks parallel to the increase in aquaculture production of fish of poorer nutritional quality. Today, more than 45% of the world's fish stocks have already been destroyed and if the fishing industry continues to harvest at the same rate, stocks are set to disappear in 15 to 20 years. For all these reasons, it is therefore essential to offer food products that can be substituted for meat products (meat or fish).

To meet this need, the agri-food industry currently offers plant protein based products. These foodstuffs are almost exclusively derived from soy, or combined with legumes (peas, lentils, chickpeas) and/or cereals (rice, wheat, oats). However, legume proteins cannot provide the same quantitative intake of essential amino acids as meat or fish. In addition, a high consumption of soy can also produce health effects (food intolerances and allergies), especially since soy is often genetically modified and treated with pesticides. What is more, despite gradual improvements in the taste quality of vegetarian products, they are tainted with a negative reputation: bland taste, high price, poor variety of marketed products, etc.

The object of the invention is to propose a substitute for meat products, which overcomes the problems of existing plant-based substitutes. For this purpose, the invention proposes a particular product containing microalgae and/or cyanobacteria.

Microalgae, marine fungi and cyanobacteria are freshwater or marine aquatic organisms with a high concentration of excellent quality nutrients, including proteins, polyunsaturated fatty acids, fiber and polysaccharides, minerals, water-soluble vitamins, pigments and antioxidants. In addition, they are first-tier organisms that accumulate relatively few pollutants and harmful compounds. What is more, the production of microalgae, marine fungi and cyanobacteria uses cultures, which does not require harvesting in the natural environment unlike other aquatic organisms, and thus allows better control of the quality and traceability of finished products without having a negative impact on natural environments or their biodiversity.

WO2010/120923 describes a plant-based pancake comprising a microalga, Chlorella protothecoides, but the products described therein do not have a fibrous structure and do not possess the organoleptic characteristics of products of animal origin.

In particular, the invention relates to a foodstuff having a fibrous structure organized in layers imitating the muscular structure resulting from the organization of myofilaments of animal flesh, comprising:
at least one plant constituent of aquatic origin selected from among microalgae or microalgae extracts, cyanobacteria or cyanobacteria extracts and marine fungi or marine fungi extracts of the genus Schizochytrium and Auriantochytrium, or a mixture of at least two of these constituents of aquatic origin, and
at least one other plant constituent,
   said constituent of aquatic origin or the mixture of at least two of said constituents of aquatic origin constituting at least 5% by weight of the foodstuff.

The invention also relates to the use of such a foodstuff as a substitute for meat food products, in particular meat or fish or a product derived from meat or fish.

Advantageously, the foodstuff described in the invention has the texture of a product of animal origin, while being GMO-free, non-allergenic and derived from a renewable and sustainable resource without any negative impact on the environment, biodiversity or natural ecosystems.

A further advantage is that the invention makes it possible to combine microalgae and/or cyanobacteria proteins with other plant proteins and long-chain polyunsaturated omega-3, and its consumption meets our daily needs for many essential elements (lipids, proteins, omega-3, iron, trace elements and/or vitamins) and our requirements in terms of nutritional and organoleptic quality.

The invention thus provides a solution both to the increasing number of consumers wishing to limit or avoid consumption of meat products by offering foodstuffs of high nutritional quality and free from toxic compounds, and at the same time to a demand for diversification of food sources in the context of a development that respects the environment and is sustainable over time.

The invention will now be described in detail.

### Definitions

By “other plant constituent” within the meaning of the invention is meant a biomass or an extract of a plant other than a microalga, a marine fungus or a cyanobacterium.

By “biomass” within the meaning of the invention is meant the entirety of the cellular material (plant, plant part, algae, microalgae, marine fungus, cyanobacteria, etc.). If no details are given when a plant is mentioned in the present application, it must be considered as biomass. It can be a raw or treated biomass.

By “plant constituent” within the meaning of the invention is meant a product of plant origin, i.e. a plant biomass or a plant extract.

By “extract” within the meaning of the invention is meant any mixture of several native molecules contained in a biomass, obtained by one or more extraction processes from said biomass.

By “meat food product” is meant meat or a meat-based food product, or fish or a fish-based food product.

By “derived product” of meat or fish is meant a product obtained by processing meat or fish, such as a spreadable product.

By “fibrous structure” or “fibrous texture” within the meaning of the invention is meant that the product has a filamentary structure, in layers, easily divisible, imitating the fibrillar structure of muscle or animal flesh.

### DETAILED DESCRIPTION OF THE INVENTION

The invention relates to a foodstuff having a fibrous structure comprising:
at least one plant constituent of aquatic origin selected from among microalgae or microalgae extracts, cyanobacteria or cyanobacteria extracts and marine fungi or marine fungi extracts of the genus Schizochytrium and Auriantochytrium, or a mixture of at least two of these plant constituents of aquatic origin, and
at least one other plant constituent, said constituent of aquatic origin or the mixture of at least two of said constituents of aquatic origin constituting at least 5% by weight of the foodstuff.

It is a foodstuff with organoleptic characteristics similar to those of a seafood, meat or a derived product.

Production of the biomass of microalgae, marine fungi and/or cyanobacteria can be carried out by any suitable method. This can be carried out by methods including autotrophy, heterotrophy or mixotrophy.

The raw biomass may be treated prior to its use in the foodstuffs described in the invention or before it is used to obtain extracts which are themselves then used in the foodstuffs described in the invention. The pretreatment of the biomass may be, for example, washing in particular to reduce its salt and preferably sodium content (desalting step), and/or a concentration by centrifugation and/or one or more filtration(s) (frontal, tangential) (microfiltration and/or ultrafiltration and/or nanofiltration) and/or dehydration by lyophilization, zeodration, atomization, and/or fluidized bed drying or forced air drying.

Any extracts of microalgae, marine fungi and/or cyanobacteria present in the foodstuff described in the invention may be of any kind and obtained by any suitable method. Preferably, these are extracts comprising oils and/or lipids and/or polysaccharides and/or proteins and/or carotenoid pigments. They can be obtained by any suitable method such as a liquid-liquid extraction of the lipid phase on a fresh biomass, previously concentrated. Separation of lipid and hydrophilic phases with a heated or unheated organic solvent (15° C. to 50° C.) accepted in human foodstuffs or GRAS (Generally Recognized As Safe) such as ethanol or ethyl acetate or acetone on dehydrated biomass. Separation/fractionation of lipids by the use of CO₂ in the supercritical phase, whether or not combined with a GRAS organic cosolvent on previously dehydrated biomass. Still more preferably, these are lipid extracts constituted by total lipids, that is to say a mixture of neutral lipids (triglycerides, cerides, etc.) and polar lipids (free fatty acids, monoglycerides, phospholipids, etc.) or purified extracts. The polar extracts are composed, mixed or unmixed, of proteins, polysaccharides, complex or simple sugars and minerals.

Preferably, the at least one plant constituent of aquatic origin is selected from among microalgae or microalgae extracts of the genus Odontella, Dunaliella, Tetraselmis, Chiorella, Haematococcus, cyanobacteria of the genus Arthrospira, Spirulina, and marine fungi or marine fungi extracts of the genus Schizochytrium and Auriantochytrium, or a mixture of at least two of these plant constituents of aquatic origin.

According to a particularly suitable embodiment, the at least one plant constituent of aquatic origin is selected from among biomass or an extract of: Odontella aurita, Schizochytrium aggregatum, Schizochytrium limacinum, Schizochytrium minutum, Dunaliella salina, Tetraselmis chuii, Haematococcus pluvialis, Chiorella sorokiniana, Arthrospira platensis, Arthrospira maxima and/or a mixture of at least two of these constituents.

These specific species present, alone or collectively, nutritional characteristics that make it possible to cover human needs in terms of lipids, omega-3 fatty acids, proteins and essential amino acids, minerals (iron, calcium, potassium, magnesium, selenium, iodine, silica, etc.), and oligonutrients (carotenoid pigments, vitamins, provitamins, etc.).

In the foodstuff described in the invention, said at least one plant constituent of aquatic origin or the mixture of at least two of said constituents of aquatic origin constitute at least 5%, preferably between 5 and 90%, by weight of the foodstuff. It must constitute at least 5% because the seafood aromas and taste come from these biomasses or specific extracts of these aquatic plants.

In addition to one or more plant constituent(s) of aquatic origin, the foodstuff described in the invention comprises at least one other plant constituent. The presence of this other plant constituent is indispensable because it makes it possible to obtain the desired texture and/or appearance and/or organoleptic characteristics, in particular the fibrous structure/texture. It is therefore a plant constituent intended to obtain a texture and/or appearance and/or organoleptic characteristics of the foodstuff described in the invention (including texture, odor and palatability) that are identical to that of fish or meat, and a nutritional quality that is at least identical, preferably higher.

It is preferably at least one plant constituent chosen from among:
gelling plant constituents, i.e. plants with a gelling power, in particular selected from among agar-agar and/or alginates and/or other plant polysaccharides (konjac, starches, pectins, maltodextrins, etc.),
vegetable fats, vegetable oils, spices, plant proteins and vegetable fibers,
deodorized coconut fat, neutral vegetable oils, pectin, paprika, gluten, extruded tofu, extruded pea protein, root vegetable fiber,
marine macroalgae.

The foodstuff described in the invention may comprise a combination of several of these constituents.

The presence of at least one gelling plant constituent is preferred to obtain a texture that is identical to that of fish or meat.

These different constituents play a role in the texturization and/or nutritional and organoleptic quality of the foodstuff described in the invention. The foodstuff described in the invention has an organoleptic quality (including texture, odor and palatability) that is identical to that of fish or meat and a nutritional quality that is at least identical, preferably higher. The foodstuff described in the invention can be obtained by any method making it possible to obtain a fibrous texture. In particular, it is obtained by comminution and/or extrusion cooking and/or 3D printing.

Preferably, the foodstuff described in the invention is obtained by a method comprising the following steps:
mixing of biomasses and/or extracts
mechanical homogenization of the hydrophobic phases (lipids and pigments of the biomasses and/or extracts used) and hydrophilic phases (proteins, peptides and polysaccharides of the biomasses and/or extracts used)
texturization by mechanical and/or physicochemical means of the homogenized mixture of compounds and extracts, preferably by comminution and/or extrusion cooking and/or 3D printing.

Preferably, if the foodstuff described in the invention comprises constituents of marine origin (microalgae, algae, marine plants or extracts of these biomasses), the method comprises a preliminary step of extracting the salt from one or more constituent(s) of marine origin that may be present in the composition (so as to limit the sodium content of the finished products and/or minimize ionic activity during the steps of mixing, homogenization and texturization of the various extracts).

In addition, according to a particularly suitable embodiment, before mixing, the method also comprises one or more of the following steps:
extraction of the compounds of interest from the different biomasses constituting the foodstuff, by any suitable method known to those skilled in the art (fractionation and/or extraction with supercritical CO₂ for example)
amalgamation of the various lipid extracts and oleoresins of the carotenoid pigments (concentrates of astaxanthin and/or paprika and/or other carotenoid pigments),
preparation of the protein extracts of the various constituents in concentrated solutions with addition of peptide concentrates and/or plant-protein hydrolysates and/or microorganisms (yeasts, fungi, bacteria)
homogeneous mixing of dietary fibers and plant polysaccharides (soluble and/or insoluble) from the various constituents.

The foodstuff described in the invention has a fibrous texture in layers. It is preferably in the form of slices and/or pieces (steak, fillets, sticks, etc.).

It can be used as a meat food product substitute. In particular, it can be used as a substitute for:
seafood, including fish or shellfish, and in particular salmon (fresh or smoked) or tuna (fresh or cooked) or shrimp, scallop, crab or lobster meat, or
meat, including meat steak.

The same method without the texturization step or with a different texturization makes it possible to obtain a product derived from seafood or meat, including in the form of a spreadable product such as, for example, a substitute for rillettes, pâtés, mousses or terrines (fish and meat).

The foodstuffs described in the invention have organoleptic characteristics (tastes, textures, colors and odors) similar to those of a seafood, meat or derived product. In addition, the foodstuffs described in the invention are rich in nutrients, i.e. they have a high nutrient density (proteins, omega-3, antioxidants, vitamins, minerals), are pollutant or contaminant-free and can be produced sustainably, i.e. without adversely affecting the environment (greenhouse gas production, surface water and groundwater pollution, soil degradation, etc.).

The invention will now be illustrated by a set of non-exhaustive examples.

### Example 1: Smoked Salmon Substitute

| | | % by |
|---|---|---|
| Constituents | Roles | weight |
| Pea protein | Texturization and source of protein | 5-15 |
| concentrate | | |
| Spirulina protein | Texturization and source of protein and essential | 5-15 |
| concentrate | amino acids | |
| O. aurita | Fish taste/flavor + salt + omega-3 fatty acids (mainly | 5-10 |
| | EPA) | |
| Schizochytrium sp. oil | Fish taste/flavor + omega-3 fatty acids (mainly DHA) | 3-6 |
| H. pluvialis oil | Orange-red color (astaxanthin) and powerful | 1-3 |
| | antioxidant content | |
| Algae gelling agents | Texturization | 2-6 |
| Vegetable oils | Taste/texture + omega-3 fatty acids (mainly alpha- | 5-10 |
| (rapeseed, flaxseed, | linolenic acid or ALA) | |
| chia seed) | | |
| Coconut fat | Structure and texturization | 1-5 |
| Pectin | Texturization | 2-5 |
| Root vegetable fiber | Structure, texturization and water retention | 5-15 |
| D. salina extract | Coloration + antioxidants | 1-4 |
| Paprika | Coloration + antioxidants | 2-4 |

### Example 2: Spreadable Smoked Salmon Product Substitute

| | | % by |
|---|---|---|
| Constituents | Roles | weight |
| Pea protein concentrate | Texturization and source of protein | 10-25 |
| Schizochytrium sp. oil | Fish taste/flavor + omega-3 fatty acids (DHA + EPA) | 5-7 |
| H. pluvialis oil | Color (astaxanthin) and antioxidant content | 1-3 |
| Root vegetable fiber | Texture and structure | 20-55 |
| Coconut fat and/or | Sapidity and texture | 15-20 |
| vegetable oils (rapeseed | | |
| and/or flaxseed and/or | | |
| chia seed and/or olive) | | |
| Pectin and/or konjac | Texture | 2-5 |
| Textured pea/tofu | Structure/texture + source of protein | 5-25 |
| protein | | |
| Algae gelling agents | Texture | 2-6 |
| D. salina extract | Coloration + antioxidants | 1-4 |
| Paprika | Coloration + antioxidants | 2-4 |
| Aromatic plant extract | Flavor + antioxidants | 0.5-3 |

### Example 3: Sliced Cooked Ham Substitute

| | | % by |
|---|---|---|
| Constituents | Roles | weight |
| Pea protein concentrate | Texturization and source of protein | 5-15 |
| Spirulina protein | Texturization and source of protein and essential amino | 5-15 |
| concentrate | acids | |
| H. pluvialis and/or D. salina | Color (astaxanthin/beta-carotene) and powerful | 0.5-2 |
| oil | antioxidant content | |
| Root vegetable fiber | Structure, texturization and water retention | 5-15 |
| Coconut fat and/or | Sapidity and texture | 5-10 |
| vegetable oils (rapeseed | | |
| and/or flaxseed and/or | | |
| chia seed and/or olive) | | |
| Chloralla powder | Texture | 1-4 |
| Alginate and/or konjac | Texture | 1-5 |
| Algae gelling agents | Texture | 2-6 |
| D. salina extract | Coloration + antioxidants | 1-4 |
| Paprika | Coloration + antioxidants | 2-4 |
| Aromatic plant extract | Flavor + antioxidants | 0.5-3 |

1. A foodstuff having a fibrous structure comprising:
at least one plant constituent of aquatic origin selected from among microalgae or microalgae extracts, cyanobacteria or cyanobacteria extracts and marine fungi or marine fungi extracts of the genus Schizochytrium and Auriantochytrium, or a mixture of at least two of these constituents of aquatic origin, and
at least one other plant constituent,
said constituent of aquatic origin or the mixture of at least two of said constituents of aquatic origin constituting at least 5% by weight of the foodstuff.

2. The foodstuff according to claim 1, characterized in that said at least one plant constituent of aquatic origin is selected from among microalgae or microalgae extracts of the genus Odontella, Dunaliella, Tetraselmis, Chlorella, Haematococcus, cyanobacteria or cyanobacteria extracts of the genus Arthrospira, Spirulina, and marine fungi or marine fungi extracts of the genus Schizochytrium and Auriantochytrium, or a mixture of at least two of these constituents of aquatic origin.

3. The foodstuff according to claim 1, characterized in that the at least one plant constituent of aquatic origin is selected from among Odontella aurita, Schizochytrium aggregatum, Schizochytrium limacinum, Schizochytrium minutum, Auriantochytrium mangrovei, Dunaliella salina, Tetraselmis chuii, Chlorella sorokiniana, Arthrospira platensis, Arthrospira maxima and Haematoccosus pluvialis or a mixture of at least two of these constituents.

4. The foodstuff according to claim 1, characterized in that said plant constituent of aquatic origin or the mixture of at least two of said constituents of aquatic origin constitutes between 5 and 90% by weight of the foodstuff.

5. The foodstuff according to claim 1, characterized in that said at least one other plant constituent is selected from among gelling plant constituents.

6. The foodstuff according to claim 1, characterized in that said at least one other plant constituent is selected from among agar-agar and/or alginates and/or other gelling plant polysaccharides.

7. The foodstuff according to claim 1, characterized in that said at least one other plant constituent is selected from among vegetable fats, vegetable oils, spices, plant proteins and vegetable fibers.

8. The foodstuff according to claim 1, characterized in that said at least one other plant constituent is selected from among deodorized coconut fat, neutral vegetable oils, pectin, paprika, gluten, extruded tofu, extruded pea protein and root vegetable fiber.

9. The foodstuff according to claim 1, characterized in that said at least one other plant constituent is selected from among marine macroalgae.

10. The foodstuff according to claim 1, characterized in that at least one constituent of aquatic origin is an extract and in that said extract consists of oils and/or lipids and/or polysaccharides and/or proteins and/or carotenoid pigments.

11. The foodstuff according to claim 1, characterized in that it is obtained by comminution and/or extrusion cooking and/or 3D printing.

12. Use of a foodstuff according to claim 1 as a meat food product substitute.

13. Use according to claim 12 as a substitute for a seafood or meat product or a product derived from seafood or meat.

14. Use according to claim 13 as a substitute for a seafood product selected from among fish and shellfish.

15. Use according to claim 1 as a salmon substitute.

16. Use according to claim 12 as a meat steak substitute.

17. Use according to claim 12 for the production of a meat food product substitute in the form of a spreadable product such as a pâté, mousse or terrine.

18. Use according to claim 17, characterized in that the meat food product substitute is selected from among fish rillette and meat pâté substitutes.
